(19) United States
(12) Patent Application Publication
(10) Pub. No.: US 2026/0031292 A1
(43) Pub. Date: Jan. 29, 2026

(54) OPERATION DEVICE AND IMAGING APPARATUS

(71) Applicant: Panasonic Intellectual Property Management Co., Ltd., Osaka (JP)

(72) Inventors: Jun SAIKI, Hyogo (JP); Takuya AMANO, Osaka (JP)

(73) Assignee: Panasonic Intellectual Property Management Co., Ltd., Osaka (JP)

(21) Appl. No.: 19/273,352

(22) Filed: Jul. 18, 2025

(30) Foreign Application Priority Data
Jul. 23, 2024 (JP) 2024-117870

(51) Int. Cl. H01H 25/06; H01H 19/14; H04N 23/50

(52) U.S. Cl. CPC H01H 25/065; H01H 19/14; H04N 23/50; H01H 2221/01; H01H 2231/046

(57) ABSTRACT

An operation device includes a dial and a dial lock member including a recessed portion. The dial includes: a lock lever member that is movable in an extending direction of a rotational center line of the dial and includes a button portion and a projecting portion, the button portion being configured to be pressed down by a user, the projecting portion being configured to engage with the recessed portion of the dial lock member to bring the dial into a non-rotatable locked state when the button portion is pressed down; and an alternate mechanism configured to moves the lock lever member so as to bring the dial into a rotatable unlocked state in which engagement between the projecting portion and the recessed portion is released after the button portion in the locked state is pressed down by a user.

### BACKGROUND

### Technical Field

The present disclosure relates to an operation device and an imaging apparatus including the operation device.

### Description of the Related Art

Conventionally, an operation device including an alternate mechanism is known. For example, an operation device described in JP 2015-125307A is configured to be able to lock a dial in a non-rotatable manner.

Specifically, when the user presses down a lock button provided on the dial once, the dial is locked and becomes in a non-rotatable state, and when the user presses down the lock button again, the dial returns to a rotatable state. That is, the alternate mechanism causes the dial to transition from a locked state to an unlocked state or vice versa by a common operation.

### SUMMARY

However, in the case of the operation device described in JP 2015-125307A, when the user presses down the lock button, a lock pin comes out of the dial and engages with a lock hole of a case that rotatably supports the dial. By this, the dial is locked so as not to be rotatable. When the user presses down the lock button again, the lock pin comes out of the lock hole and returns into the dial. By this, the dial is rotatably unlocked. For this reason, in the case of the operation device described in JP 2015-125307A, the lock button and the lock pin are detachably coupled in a direction of a rotational center line of the dial. That is, the lock button must be separated from the lock pin once. As a result of securing a stroke necessary for the separation, thickness of the dial (size in an extending direction of the rotational center line) becomes large.

In view of the above, an object of the present disclosure is to reduce thickness of a dial equipped with an alternate mechanism in an operation device including the dial.

In order to solve the above problem, according to an aspect of the present disclosure, an operation device is provided that includes:
a dial; and
a dial lock member including a recessed portion, wherein
the dial includes:
a lock lever member that is movable in an extending direction of a rotational center line of the dial and includes a button portion and a projecting portion, the button portion being configured to be pressed down by a user, the projecting portion being configured to engage with the recessed portion of the dial lock member to bring the dial into a non-rotatable locked state when the button portion is pressed down; and
an alternate mechanism configured to move the lock lever member so as to bring the dial into a rotatable unlocked state in which engagement between the projecting portion and the recessed portion is released after the button portion in the locked state is pressed down by a user.

Further, according to another aspect of the present disclosure,
an imaging apparatus including the above-described operation device is provided.

According to the present disclosure, it is possible to reduce thickness of a dial equipped with an alternate mechanism in an operation device including the dial.

### BRIEF DESCRIPTION OF DRAWINGS

FIG. 1 is a perspective view of an imaging apparatus according to an embodiment of the present disclosure;

FIG. 2 is a perspective view of an operation device according to an embodiment of the present disclosure;

FIG. 3 is an exploded perspective view of the operation device;

FIG. 4 is a lower perspective view of a dial in the operation device;

FIG. 5 is a cross-sectional view of the dial in an unlocked state;

FIG. 6A is an upper exploded perspective view of the dial;

FIG. 6B is a lower exploded perspective view of the dial;

FIG. 7A is a perspective view of the operation device illustrating an unlocked state in which the dial is rotatable with respect to a dial lock member;

FIG. 7B is a perspective view of the operation device illustrating a locked state in which the dial is non-rotatable with respect to the dial lock member;

FIG. 8 is a perspective view of a rotating body included in an alternate mechanism;

FIG. 9 is a lower perspective view of a lock lever member illustrating an engagement portion engaged with the rotating body;

FIG. 10A is an upper perspective view of a rotating body support member included in the alternate mechanism;

FIG. 10B is a lower perspective view of the rotating body support member;

FIG. 10C is a top view of the rotating body support member;

FIG. 10D is a bottom view of the rotating body support member;

FIG. 11A is an upper perspective view of the rotating body support member in a state of supporting the rotating body;

FIG. 11B is a lower perspective view of the rotating body support member in a state of supporting the rotating body;

FIG. 11C is a bottom view of the rotating body support member in a state of supporting the rotating body;

FIG. 12 is a diagram schematically illustrating movement of a second cam follower portion of the rotating body when a state of the dial transitions in order of an unlocked state, a locked state, and the unlocked state;

FIG. 13A is a cross-sectional view of the dial in a state where the lock lever member is pressed down to the maximum from the unlocked state;

FIG. 13B is a bottom view of the rotating body and the rotating body support member corresponding to FIG. 13A;

FIG. 14A is a cross-sectional view of the dial in the locked state;

FIG. 14B is a bottom view of the rotating body and the rotating body support member corresponding to FIG. 14A;

FIG. 15A is a cross-sectional view of the dial in a state where the lock lever member is pressed down to the maximum from the locked state;

FIG. 15B is a bottom view of the rotating body and the rotating body support member corresponding to FIG. 15A;

FIG. 16 is a diagram for explaining assembly of a first subassembly in the dial;

FIG. 17 is a perspective view of the first subassembly;

FIG. 18 is a diagram for explaining assembly of a second subassembly in the dial; and

FIG. 19 is a diagram for explaining assembly of the first subassembly and the second subassembly.

### DETAILED DESCRIPTION

Hereinafter, an embodiment will be described in detail with reference to the drawings as appropriate. However, more detailed description than necessary may be omitted. For example, detailed description of already well-known matters and repetition of description of substantially the same configurations will be omitted in some cases. This is to avoid unnecessary redundancy of description below and to facilitate understanding of those skilled in the art.

Note that the inventor(s) provide the accompanying drawings and the description below so that those skilled in the art can fully understand the present disclosure, and do not intend to limit the subject matter described in claims by these drawings and description.

Hereinafter, an imaging apparatus according to an embodiment of the present disclosure will be described with reference to the drawings.

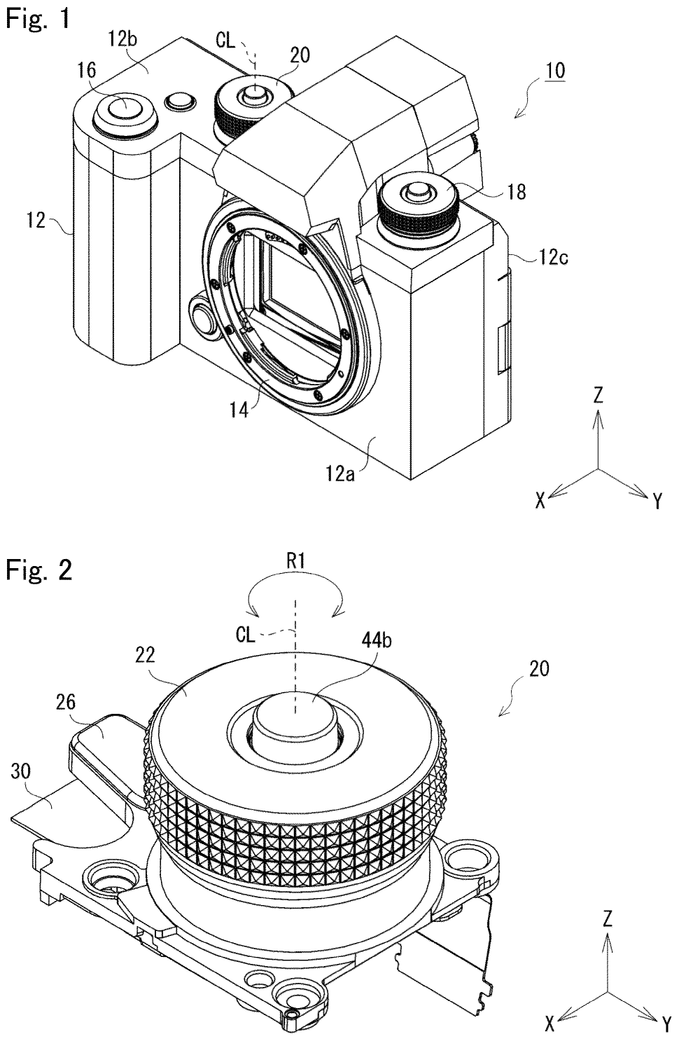

FIG. 1 is a perspective view of the imaging apparatus according to an embodiment of the present disclosure. Note that an X-Y-Z orthogonal coordinate system shown in the drawings is for facilitating understanding of an embodiment of the present disclosure, and not for limiting an embodiment of the present disclosure. An X-axis direction is a front-rear direction of the imaging apparatus, a Y-axis direction is a left-right direction, and a Z-axis direction is a height direction. Further, in the present description, the side on which a subject of the imaging apparatus exists is referred to as “front side”, and the side on which the imaging apparatus exists is referred to as “rear side”.

As illustrated in FIG. 1, an imaging apparatus 10 according to the present embodiment includes a casing 12 and a lens mount 14 that is provided on a front surface 12a of the casing 12 and to which a lens barrel (not illustrated) is detachably attached. Further, the imaging apparatus 10 includes a plurality of operation devices such as a button to be operated by the user. For example, when the user operates a shutter button 16, operation devices 18 and 20 provided on an upper surface 12b of the casing 12, a touch display, a button, and the like provided on a rear surface 12c of the casing 12, the imaging apparatus 10 executes various functions corresponding to the user's operation.

Hereinafter, further features of the operation devices 18 and 20 in the imaging apparatus 10 according to the present embodiment will be described. Note that, since the operation devices 18 and 20 have substantially the same structure, only the operation device 20 will be described.

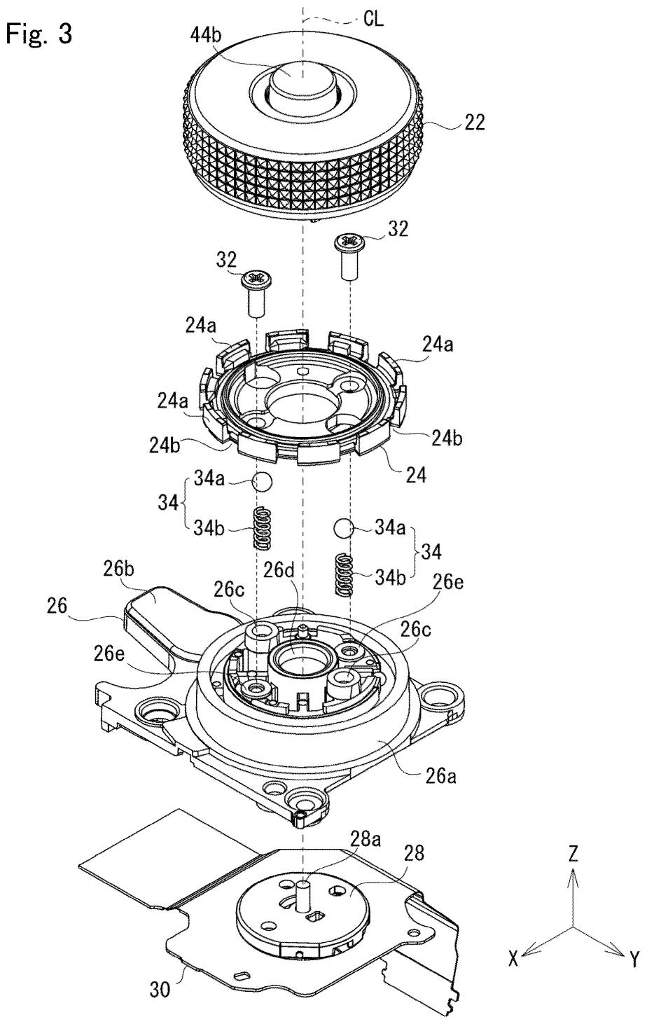

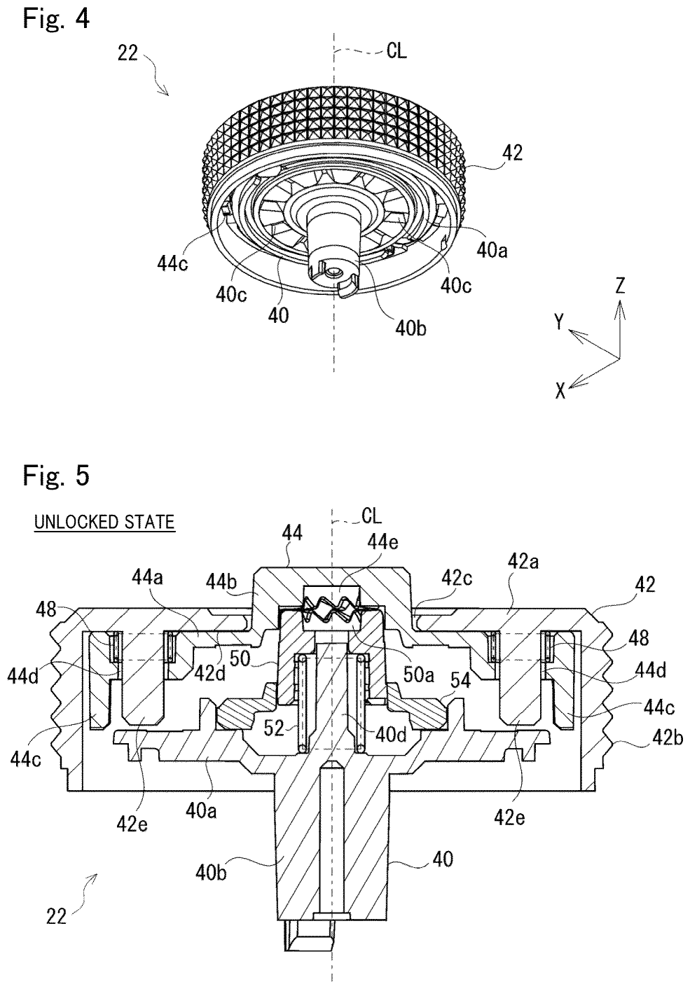

FIG. 2 is a perspective view of the operation device according to an embodiment of the present disclosure. Further, FIG. 3 is an exploded perspective view of the operation device. Furthermore, FIG. 4 is a lower perspective view of a dial in the operation device. Then, FIG. 5 is a cross-sectional view of the dial in an unlocked state.

As illustrated in FIGS. 2 and 3, the operation device 20 includes a dial 22 rotated by the user, a dial lock member 24 that selectively restricts rotation of the dial 22, a bracket member 26 to which the dial lock member 24 is fixed, a contact rotor 28 that includes a contact brush (not illustrated) and detects a rotational angular position of the dial 22, and a circuit board 30 on which an electrode portion obtained by performing gold plating processing on a copper foil portion on printed wiring is mounted.

The dial 22 is supported by the bracket member 26 so as to be rotatable about a rotational center line CL extending in the height direction (Z-axis direction) of the imaging apparatus 10. Further, although details will be described later, the dial 22 includes a plurality of constituent elements as illustrated in FIG. 5. The dial 22 will be described later in detail.

In the present embodiment, the dial lock member 24 is an annular member, and includes a plurality of lock wall portions 24a protruding in an extending direction of the rotational center line CL (Z-axis direction) of the dial 22 at an outer peripheral edge of the dial lock member 24. A plurality of the lock wall portions 24a are arranged side by side in a rotational direction R1 of the dial 22 at intervals. Note that the dial lock member 24 is fixed to the bracket member 26 via a fixing screw 32.

The bracket member 26 includes a cylinder portion 26a passing through a through hole (not illustrated) formed in the casing 12, and a fixed portion 26b fixed to an inner surface of the casing 12 on the side opposite to the upper surface 12b of the casing 12. Further, a dial support portion 26d having a cylindrical shape that rotatably supports a shaft portion 40b of the dial 22 illustrated in FIG. 4 is provided in the cylinder portion 26a. The dial lock member 24 is fixed to a boss portion 26e in the cylinder portion 26a of the bracket member 26 by the fixing screw 32.

The contact rotor 28 is what is called a rotary switch, and includes a screw portion 28a connected to the dial 22. Specifically, the screw portion 28a engages with a female threaded hole formed in the shaft portion 40b of the dial 22 illustrated in FIG. 4. The contact rotor 28 is mounted on the circuit board 30 so as to be rotatable about the rotational center line CL with respect to the circuit board 30. Further, a contact brush is provided on a surface facing the circuit board 30 in the contact rotor 28, and a plurality of electrode portions selectively electrically connected by the contact brush are provided on the circuit board 30. Due to rotation of the contact rotor 28, the contact brush revolves around the rotational center line CL, and electrically connects two electrode portions among a plurality of electrode portions. Depending on a rotational angular position of the contact rotor 28, electrode portions electrically connected by the contact brush are different. A rotational angular position of the contact rotor 28 can be detected based on current flowing through two electrode portions electrically connected by the contact brush. The circuit board 30 outputs a signal corresponding to the rotational angular position to a controller including a processor such as a CPU in the imaging apparatus 10. Based on a signal from the circuit board 30, the controller acquires the rotational angular position of the dial 22 connected to the contact rotor 28 via the screw portion 28a of the contact rotor 28, and executes an operation corresponding to the rotational angular position of the dial 22. That is, a different operation of the imaging apparatus 10 is assigned to each of a plurality of predetermined rotational angular positions of the dial 22.

Note that, in the case of the present embodiment, the dial 22 is biased by a plurality of ball plungers 34 so as to be positioned at each of a plurality of predetermined rotational angular positions. The ball plunger 34 includes a ball 34a that comes into contact with the dial 22 and a spring 34b that biases the ball 34a toward the dial 22. The ball 34a and the spring 34b are accommodated in a pocket 26c formed in the cylinder portion 26a of the bracket member 26. As illustrated in FIG. 4, on the back side of the dial 22, a plurality of recessed portions 40c into which a part of the ball 34a of the ball plunger 34 is fitted are provided side by side in the rotational direction R1 of the dial 22. The ball 34a of the ball plunger 34 selectively fits into a plurality of the recessed portions 40c, so that the dial 22 is positioned at any one of a plurality of predetermined rotational angular positions.

As described above, the dial 22 can be positioned at each of a plurality of predetermined rotational angular positions via the ball plunger 34. Further, the dial 22 is configured to be fixable (lockable) in a state of being positioned at any one of a plurality of predetermined rotational angular positions. That is, the dial 22 is configured to be non-rotatable in a positioned state.

Specifically, the dial 22 is configured to be switched between an unlocked state (rotatable state) and a locked state (non-rotatable state) by a user's operation. Hereinafter, the configuration of the dial 22 will be described.

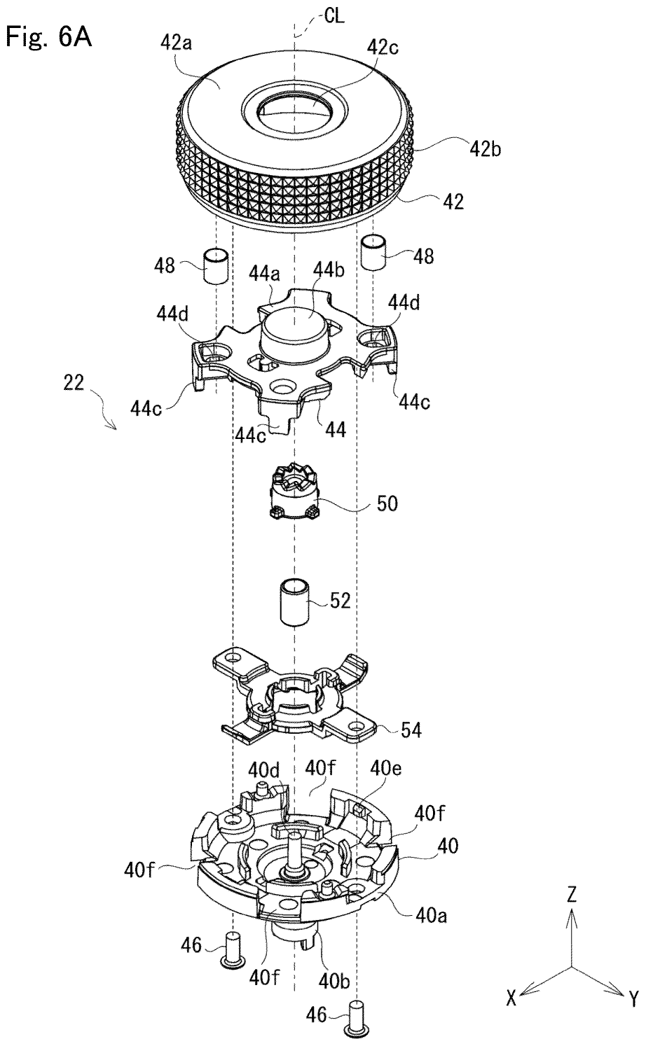

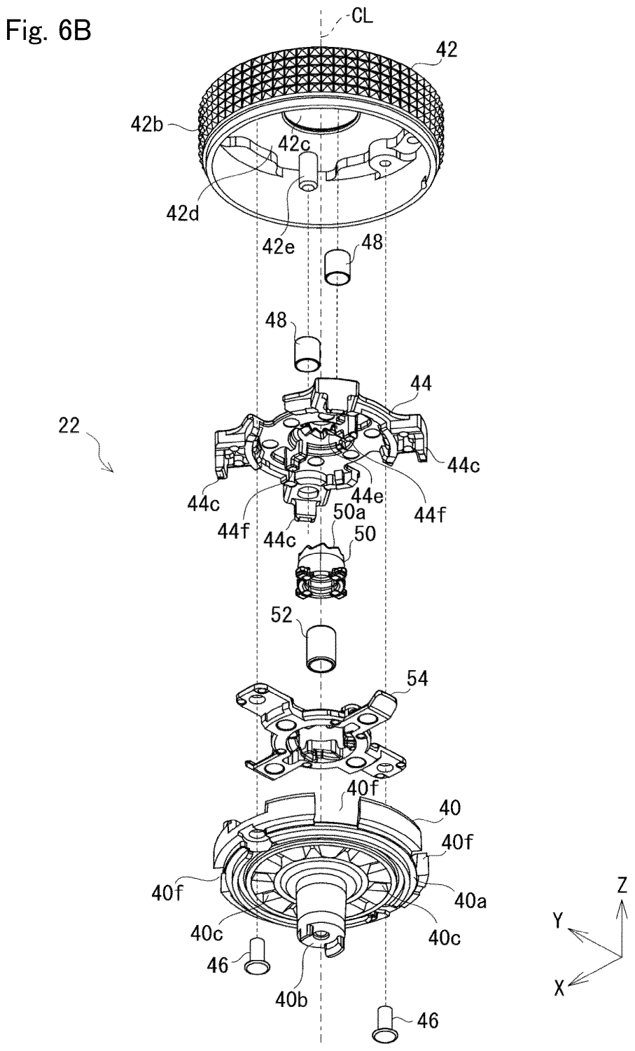

FIGS. 6A and 6B are an upper exploded perspective view and a lower exploded perspective view of the dial.

As illustrated in FIGS. 5, 6A, and 6B, the dial 22 includes a dial base 40, a dial cap 42 rotated by the user, and a lock lever member 44 for fixing the dial 22 to the dial lock member 24.

The dial base 40 includes a main body portion 40a having a disk shape, the shaft portion 40b that extends in an extending direction (Z-axis direction) of the rotational center line CL from the center of the main body portion 40a and is connected to the screw portion 28a of the contact rotor 28, and a plurality of the recessed portions 40c that engage with the ball 34a of the ball plunger 34.

The dial cap 42 includes a top plate 42a and a cylindrical side wall portion 42b protruding in an extending direction of the rotational center line CL from an outer peripheral edge of the top plate 42a. Although details will be described later, a through hole 42c is formed at the center of the top plate 42a. Further, in the case of the present embodiment, an outer peripheral surface of the side wall portion 42b is knurled. The user grips the outer peripheral surface of the side wall portion 42b of the dial cap 42 and rotates the dial 22 about the rotational center line CL.

The dial cap 42 is also attached to the dial base 40 via a plurality of fixing screws 46 as illustrated in FIGS. 6A and 6B. That is, the dial base 40 and the dial cap 42 are fixed so as not to be able to be displaced or rotated with respect to each other.

As illustrated in FIG. 5, the lock lever member 44 includes a main body portion 44a accommodated in a space between the dial base 40 and the dial cap 42, a button portion 44b that protrudes from the main body portion 44a and passes through the through hole 42c of the dial cap 42, and a plurality of projecting portions 44c that engage with the dial lock member 24 to lock the dial 22 in a non-rotatable manner.

In the dial 22, the lock lever member 44 is provided to be movable in an extending direction (Z-axis direction) of the rotational center line CL. Specifically, the main body portion 44a of the lock lever member 44 is provided to be movable in an extending direction of the rotational center line CL between the dial base 40 and the dial cap 42.

In the case of the present embodiment, as illustrated in FIG. 5 and FIG. 6B, a plurality of guide pins 42e protruding in an extending direction (Z-axis direction) of the rotational center line CL are provided on a back surface 42d of the top plate 42a of the dial cap 42. A plurality of guide holes 44d guided by a plurality of the guide pins 42e are formed in the main body portion 44a of the lock lever member 44. The lock lever member 44 is provided in the dial 22 so as to be movable in an extending direction of the rotational center line CL in a state where rotation around the rotational center line CL is restricted with the guide pin 42e entering the guide hole 44d. Note that, in the case of the present embodiment, as illustrated in FIGS. 6A and 6B, the lock lever member 44 engages with a notched portion 40f formed in an outer peripheral edge of the dial base 40 so as to be movable in an extending direction of the rotational center line CL, and rotation is restricted by the notched portion 40f.

The button portion 44b of the lock lever member 44 is exposed to the outside through the through hole 42c of the dial cap 42. Further, the button portion 44b is pressed down by the user. When the button portion 44b is pressed down by the user, the entire lock lever member 44 is pressed down.

A plurality of the projecting portions 44c of the lock lever member 44 selectively restrict rotation of the dial 22 with respect to the dial lock member 24.

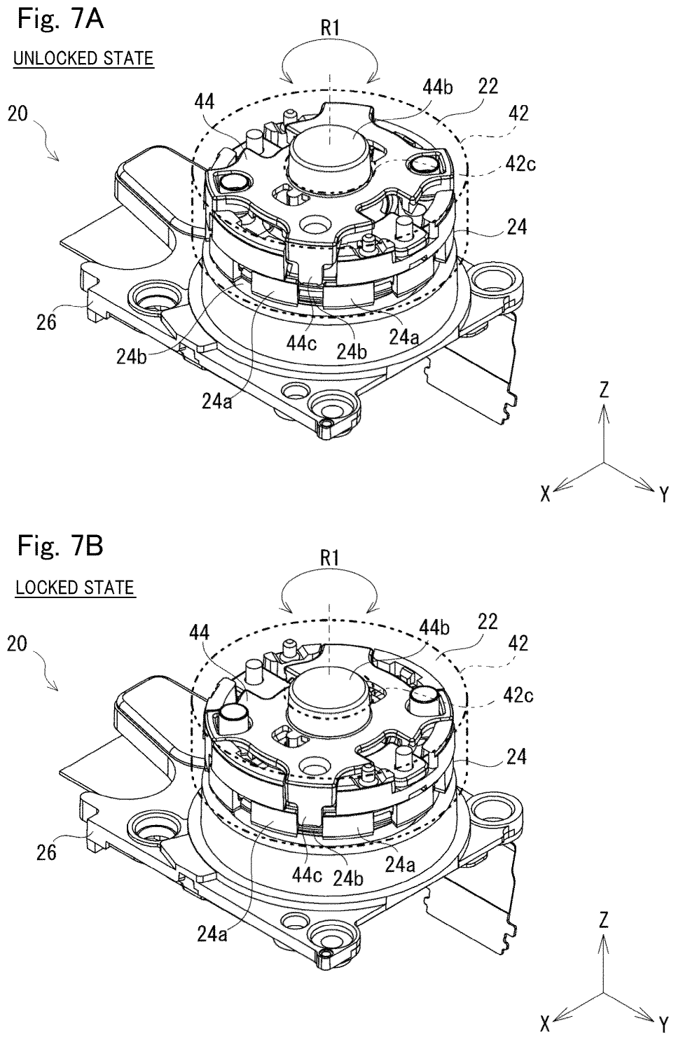

FIG. 7A is a perspective view of the operation device illustrating an unlocked state in which the dial is rotatable with respect to the dial lock member. Further, FIG. 7B is a perspective view of the operation device illustrating a locked state in which the dial is non-rotatable with respect to the dial lock member. Note that, in FIGS. 7A and 7B, the dial cap 42 is indicated by a two-dot chain line so that the inside of the dial 22 can be seen.

As illustrated in FIGS. 7A and 7B, a plurality of the projecting portions 44c of the lock lever member 44 selectively engage with a plurality of recessed portions 24b of the dial lock member 24. In the case of the present embodiment, a plurality of the recessed portions 24b of the dial lock member 24 are gaps between two of the lock wall portions 24a adjacent to each other in the rotational direction R1 of the dial 22.

As illustrated in FIG. 7A, in the unlocked state, a plurality of the projecting portions 44c of the lock lever member 44 do not enter a plurality of the recessed portions 24b of the dial lock member 24. For this reason, the dial 22 can rotate with respect to the dial lock member 24 about the rotational center line CL.

On the other hand, as illustrated in FIG. 7B, in the locked state, a plurality of the projecting portions 44c of the lock lever member 44 enter a plurality of the recessed portions 24b. That is, movement in the rotational direction R1 of each of a plurality of the projecting portions 44c is limited by a plurality of the lock wall portions 24a. For this reason, the dial 22 cannot rotate with respect to the dial lock member 24 about the rotational center line CL.

The dial 22 is configured such that the unlocked state illustrated in FIG. 7A and the locked state illustrated in FIG. 7B are alternately switched every time the user presses down the button portion 44b of the lock lever member 44.

First, when the user presses down the button portion 44b of the lock lever member 44 of the dial 22 in the unlocked state illustrated in FIG. 7A, the entire lock lever member 44 moves downward, and as illustrated in FIG. 7B, a plurality of the projecting portions 44c of the lock lever member 44 engage with a plurality of the recessed portions 24b of the dial lock member 24. As a result, the dial 22 transitions from the unlocked state to the locked state.

Further, when the user presses down the button portion 44b of the lock lever member 44 of the dial 22 in the locked state illustrated in FIG. 7B, the entire lock lever member 44 moves upward, and as illustrated in FIG. 7A, a plurality of the projecting portions 44c of the lock lever member 44 are separated from a plurality of the recessed portions 24b of the dial lock member 24. As a result, the dial 22 transitions from the locked state to the unlocked state.

The pressing-down operation of the button portion 44b of the lock lever member 44 by the user as a trigger is the same, but a moving direction (that is, a downward direction) of the lock lever member 44 when transitioning from the unlocked state to the locked state is different from a moving direction (that is, an upward direction) of the lock lever member 44 when transitioning from the locked state to the unlocked state. In order to realize such behavior of the lock lever member 44, the dial 22 includes an alternate mechanism.

Note that the “alternate mechanism” refers to a mechanism that transitions a state of a device from a first state to a second state or vice versa, for example, by the same operation of the user on a button or the like. That is, in a case where a state of a device is the first state when a user's operation is performed, the device transitions from the first state to the second state. Further, in a case where a state of the device is the second state when a user's operation is performed, the device transitions from the second state to the first state. In the case of the present embodiment, when the dial 22 is in the unlocked state when the user presses down the button portion 44b, the dial 22 transitions from the unlocked state to the locked state. Further, when dial 22 is in the locked state when the user presses down the button portion 44b, the dial 22 transitions from the locked state to the unlocked state.

In the case of the present embodiment, as illustrated in FIGS. 5, 6A, and 6B, the dial 22 includes a coil spring (first biasing member) 48 that biases the lock lever member 44. Specifically, the coil spring 48 biases the lock lever member 44 in a direction (first direction) in which a plurality of the projecting portions 44c of the lock lever member 44 engage with a plurality of the recessed portions 24b of the dial lock member 24, that is, in a direction in which the lock lever member 44 approaches the dial base 40. In the case of the present embodiment, as illustrated in FIG. 5, the coil spring 48 is arranged between the top plate 42a of the dial cap 42 and the lock lever member 44. Furthermore, the coil spring 48 is inserted into and supported by the guide pin 42e of the dial cap 42.

For this reason, in the case of the present embodiment, the alternate mechanism of the dial 22 is configured to continuously bias the lock lever member 44 in an opposite direction (second direction) to a biasing direction of the coil spring 48 with biasing force larger than biasing force of the coil spring 48 in the unlocked state. Further, the alternate mechanism is configured to release bias to the lock lever member 44 in the locked state.

In the case of the present embodiment, as illustrated in FIGS. 5, 6A, and 6B, the alternate mechanism of the dial 22 includes a rotating body 50 provided between the lock lever member 44 and the dial base 40, a coil spring 52 that biases the rotating body 50, and a rotating body support member 54 that supports the rotating body 50.

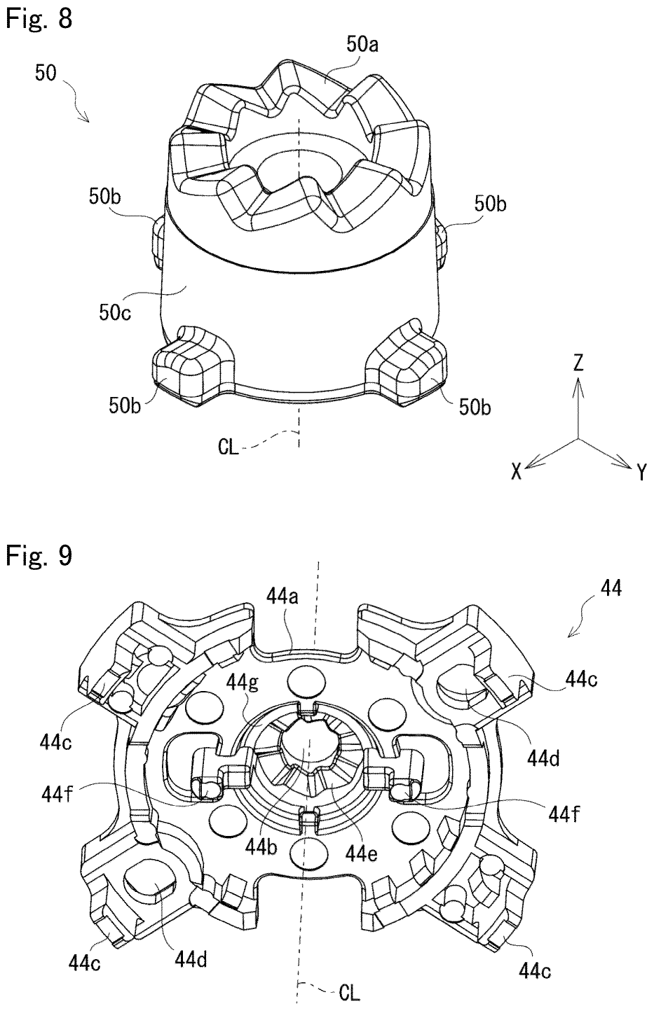

FIG. 8 is a perspective view of the rotating body included in the alternate mechanism. Further, FIG. 9 is a lower perspective view of the lock lever member illustrating an engaging portion engaging with the rotating body.

As illustrated in FIGS. 5 and 8, in the case of the present embodiment, the rotating body 50 is a cylindrical member. The rotating body 50 includes a first cam follower portion 50a having a crown gear shape on an end surface facing the lock lever member 44. As illustrated in FIGS. 5 and 9, a cam portion 44e having a crown gear shape and capable of engaging with the first cam follower portion 50a of the rotating body 50 is formed in a portion of the lock lever member 44 facing the first cam follower portion 50a of the rotating body 50. In the case of the present embodiment, the button portion 44b of the lock lever member 44 has a bottomed cylindrical shape, and the cam portion 44e is formed on an inner bottom surface of the button portion 44b. For this reason, at least a part of the rotating body 50 is accommodated in the button portion 44b. As a result, as compared with a case where at least a part of the rotating body 50 is not accommodated in the button portion 44b (for example, as compared with a case where the button portion 44b is solid) unlike the above, size in an extending direction (Z-axis direction) of the rotational center line CL of the dial 22 is reduced. Note that FIG. 5 illustrates a state in which the first cam follower portion 50a of the rotating body 50 and the cam portion 44e of the lock lever member 44 do not engage with each other.

Further, the rotating body 50 includes a plurality of second cam follower portions 50b having a projecting shape and protruding outward in a direction intersecting an extending direction (Z-axis direction) of the rotational center line CL. Details of the second cam follower portion 50b will be described later.

The coil spring 52 of the alternate mechanism biases the rotating body 50 toward the lock lever member 44. As illustrated in FIG. 5, at least a part of the coil spring 52 is accommodated in the rotating body 50 having a cylindrical shape. As a result, as compared with a case where at least a part of the coil spring 52 is not accommodated in the rotating body 50 (for example, as compared with a case where the rotating body 50 is solid) unlike the above, size in an extending direction (Z-axis direction) of the rotational center line CL of the dial 22 is reduced. Further, as illustrated in FIG. 5, the coil spring 52 is inserted into and supported by a support pin 40d provided on the main body portion 40a of the dial base 40 and extending in an extending direction (Z-axis direction) of the rotational center line CL.

As illustrated in FIG. 5, the coil spring 52 also biases the rotating body 50 toward the lock lever member 44 with biasing force larger than biasing force of the coil spring 48 that biases the lock lever member 44 toward the rotating body 50. By this, the lock lever member 44 comes into contact with the back surface 42d of the top plate 42a of the dial cap 42. As a result, as illustrated in FIGS. 5 and 7A, the button portion 44b of the lock lever member 44 protrudes from the through hole 42c of the dial cap 42 by a maximum protrusion amount. Note that biasing force of each of the coil springs 48 and 52 is set to biasing force with which the lock lever member 44 moves when the user presses down the button portion 44b of the lock lever member 44 with a fingertip.

The rotating body support member 54 of the alternate mechanism supports the rotating body 50 so as to be movable in an extending direction (Z-axis direction) of the rotational center line CL and so as to be rotatable about the rotational center line CL.

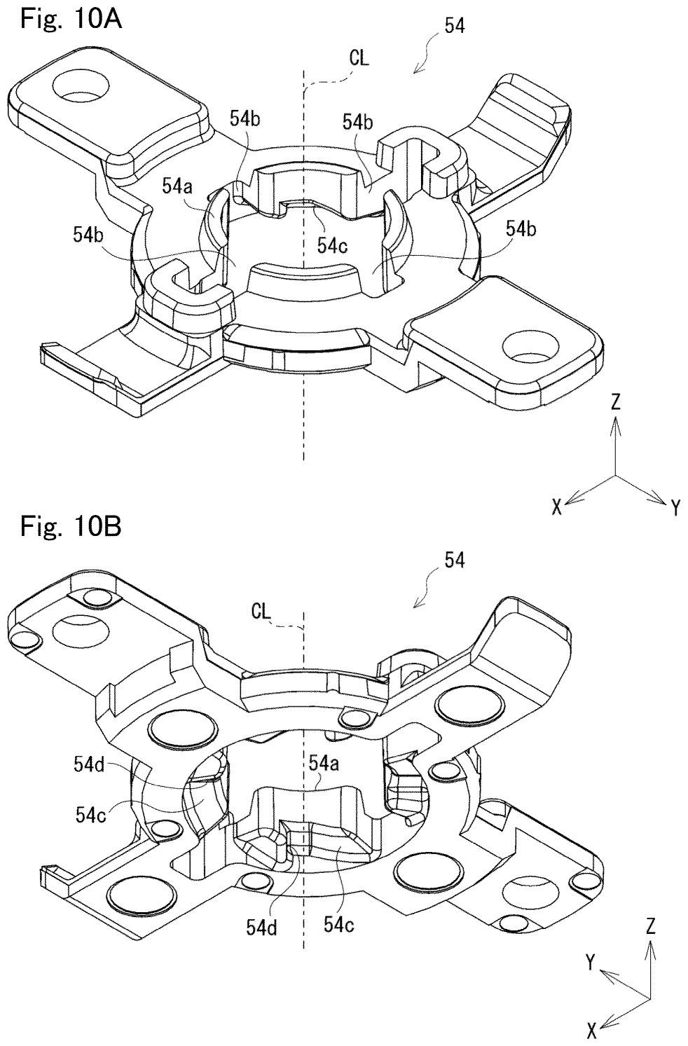

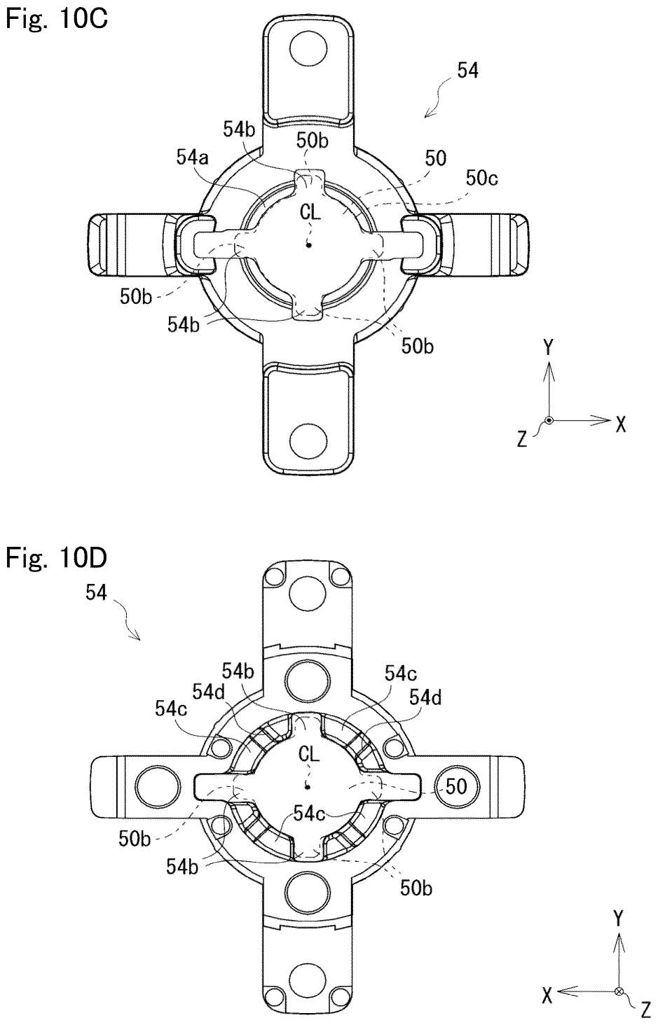

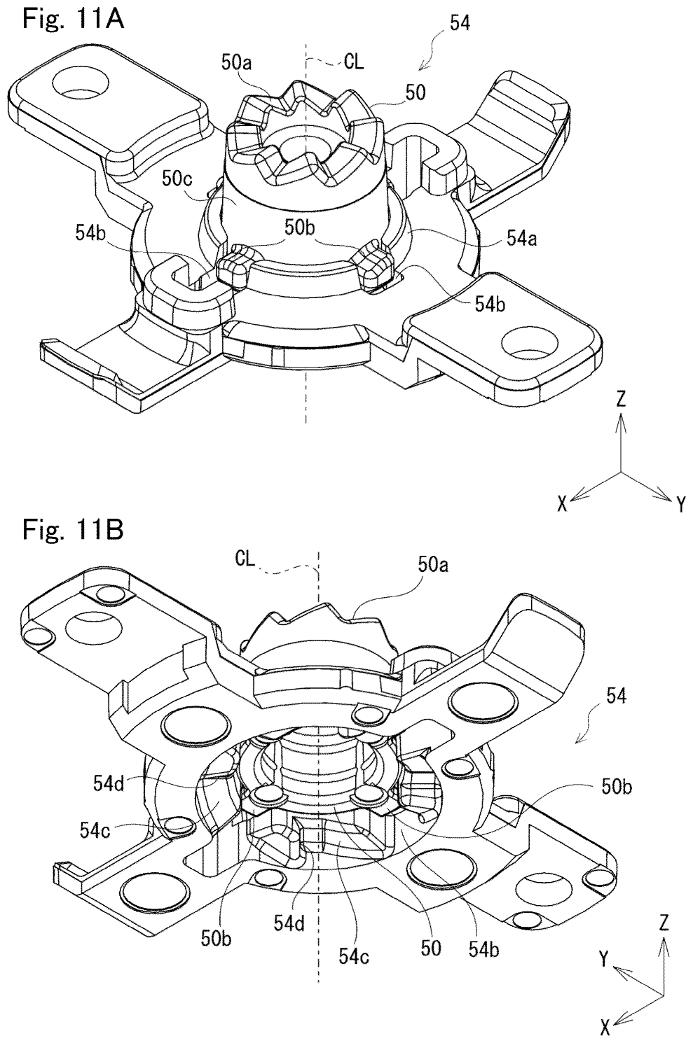

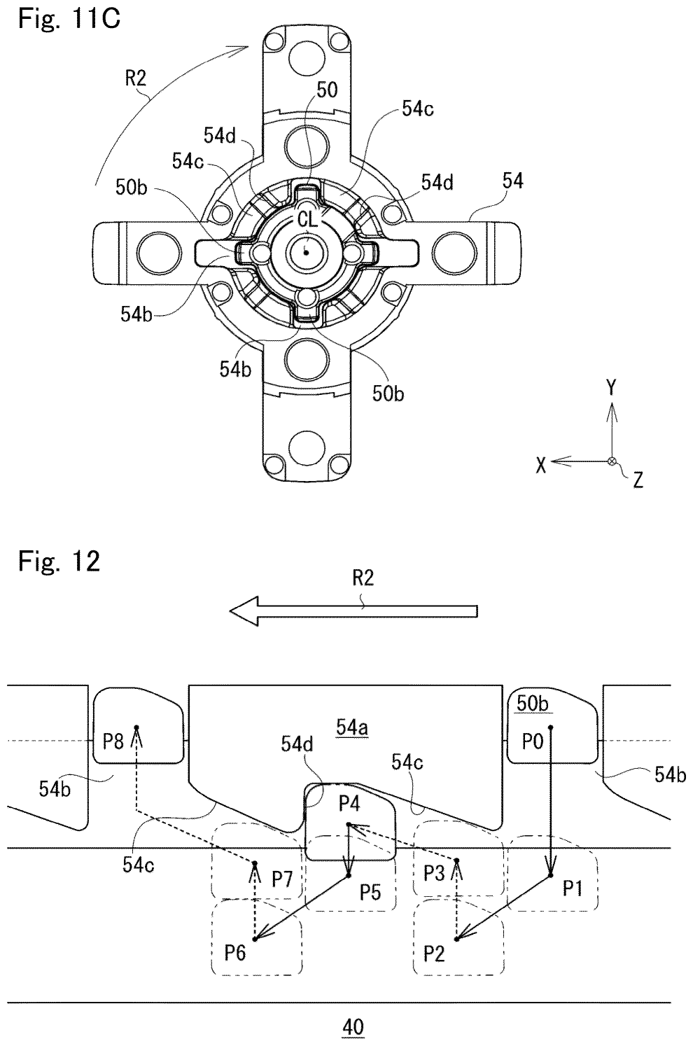

FIGS. 10A to 10D are an upper perspective view, a lower perspective view, a top view, and a bottom view of the rotating body support member included in the alternate mechanism. Note that, in FIGS. 10C and 10D, the rotating body 50 is indicated by a two-dot chain line. Further, FIGS. 11A to 11C are an upper perspective view, a lower perspective view, and a bottom view of the rotating body support member in a state of supporting the rotating body. Note that FIGS. 11A to 11C correspond to FIGS. 5 and 7A, and illustrate the rotating body 50 and the rotating body support member 54 when the dial 22 is in the unlocked state.

As illustrated in FIGS. 10A to 10D, the rotating body support member 54 includes a cylindrical portion 54a that supports an outer peripheral surface 50c of the rotating body 50 illustrated in FIG. 8 in a manner that the rotating body 50 is movable in an extending direction (Z-axis direction) of the rotational center line CL. A plurality of guide grooves 54b extending in an extending direction of the rotational center line CL and guiding a plurality of the second cam follower portions 50b of the rotating body 50 are formed in the cylindrical portion 54a.

As illustrated in FIGS. 11A and 11B, while the second cam follower portion 50b exists in the guide groove 54b, the rotating body 50 cannot rotate in the cylindrical portion 54a of the rotating body support member 54. When the rotating body 50 moves in an extending direction (Z-axis direction) of the rotational center line CL and the second cam follower portion 50b comes out of the guide groove 54b, as illustrated in FIG. 11C, the rotating body 50 becomes rotatable in a rotational direction R2 about the rotational center line CL. Details of the rotational direction R2 will be described later.

Note that, in the case of the present embodiment, a plurality of rib portions 44f protruding in an extending direction (Z-axis direction) of the rotational center line CL of the lock lever member 44 illustrated in FIG. 6B enter some of the guide grooves 54b. By this, rotation about the rotational center line CL of the lock lever member 44 is restricted.

Further, as illustrated in FIGS. 10B, 10D, 11B, and 11C, the rotating body support member 54 includes a cam surface 54c on which a plurality of the second cam follower portions 50b of the rotating body 50 coming out of the guide groove 54b are driven. The cam surface 54c is formed on an end surface of the cylindrical portion 54a (an end surface on the side far from the lock lever member 44). The cam surface 54c includes an inclined surface that is inclined while extending in the rotational direction R2 of the rotating body 50 between the guide grooves 54b. Although described in detail later, the second cam follower portion 50b coming out of the guide groove 54b moves to a position facing the cam surface 54c and then is pressed toward the cam surface 54c by biasing force of the coil spring 52. The second cam follower portion 50b that is pressed slides in the rotational direction R2 on the cam surface 54c due to inclination of the cam surface 54c. As a result, the rotating body 50 as a whole rotates about the rotational center line CL. Note that, in the case of the present embodiment, a stopper portion 54d having a step shape that limits movement of the second cam follower portion 50b is provided in a substantially central portion of an inclined surface of the cam surface 54c.

Hereinafter, movement of a constituent element of the dial 22 when transitioning from the locked state to the unlocked state and when transitioning from the unlocked state to the locked state will be described. The description will be made based on movement of the second cam follower portion 50b of the rotating body 50.

FIG. 12 is a diagram schematically illustrating movement of the second cam follower portion of the rotating body when a state of the dial transitions in order of the unlocked state, the locked state, and the unlocked state. That is, the diagram illustrates movement of the second cam follower portion 50b of the rotating body 50 when the cylindrical portion 54a of the rotating body support member 54 is viewed from the rotational center line CL.

First, when the dial 22 is in the unlocked state, as illustrated in FIG. 5, the main body portion 44a of the lock lever member 44 is in contact with the back surface 42d of the top plate 42a of the dial cap 42 and is separated from the dial base 40 to the maximum. As a result, the button portion 44b of the lock lever member 44 protrudes from the through hole 42c of the dial cap 42 by a maximum protruding amount. Further, the rotating body 50 is also separated from dial base 40 to the maximum. At this time, as illustrated in FIG. 12, the second cam follower portion 50b of the rotating body 50 is located at a position P0 in the guide groove 54b of the rotating body support member 54. When the second cam follower portion 50b is located at the position P0, the rotating body 50 cannot rotate about the rotational center line CL. That is, as illustrated in FIG. 11A, the cylindrical portion 54a of the rotating body support portion 54 has height (size in an extending direction (Z-axis direction) of the rotational center line CL) by which the rotating body 50 does not come out of the cylindrical portion 54a when the rotating body 50 is separated from the dial base 40 to the maximum. Then, as illustrated in FIG. 7A, the projecting portion 44c of the dial cap 42 does not enter the recessed portion 24b of the dial lock member 24. Then, the cam portion 44e of the lock lever member 44 and the first cam follower portion 50a of the rotating body 50 do not engage with each other.

When the user presses down the button portion 44b of the lock lever member 44 of the dial 22 in the unlocked state illustrated in FIG. 5, the lock lever member 44 presses down the rotating body 50. By the above, as illustrated in FIG. 12, the second cam follower portion 50b of the rotating body 50 moves toward the dial base 40 in the guide groove 54b of the rotating body support member 54. Note that, in FIG. 12, a movement path of the second cam follower portion 50b is indicated by a solid arrow and a broken arrow. The solid arrow indicates a movement path when pressing force (pressing force from a user's finger) acts on the button portion 44b, and the broken arrow indicates a movement path when no pressing force acts on the button portion 44b.

When the user continues to press down the button portion 44b of the lock lever member 44, as illustrated in FIG. 12, the second cam follower portion 50b of the rotating body 50 reaches a position P1 outside the guide groove 54b of the rotating body support member 54. By the above, the rotating body 50 becomes in a state of rotatable about the rotational center line CL.

When the second cam follower portion 50b of the rotating body 50 reaches the position P1, the cam portion 44e of the lock lever member 44 and the first cam follower portion 50a of the rotating body 50, which do not engage with each other as illustrated in FIG. 5, start to engage with each other. Specifically, the rotating body 50 starts to rotate in the rotational direction R2 in order for engaging. At this time, since the button portion 44b of the lock lever member 44 is continuously pressed down by the user, the rotating body 50 rotates in the rotational direction R2 while both the lock lever member 44 and the rotating body 50 move toward the dial base 40. As a result, as illustrated in FIG. 12, the second cam follower portion 50b of the rotating body 50 moves to a position P2 between the cam surface 54c of the rotating body support member 54 and the dial base 40 (however, the second cam follower portion 50b is not in contact with the cam surface 54c). Note that a tooth shape of each of the cam portion 44e of the lock lever member 44 and the first cam follower portion 50a of the rotating body 50 is designed so that the rotating body 50 rotates in the rotational direction R2 at the time of engaging.

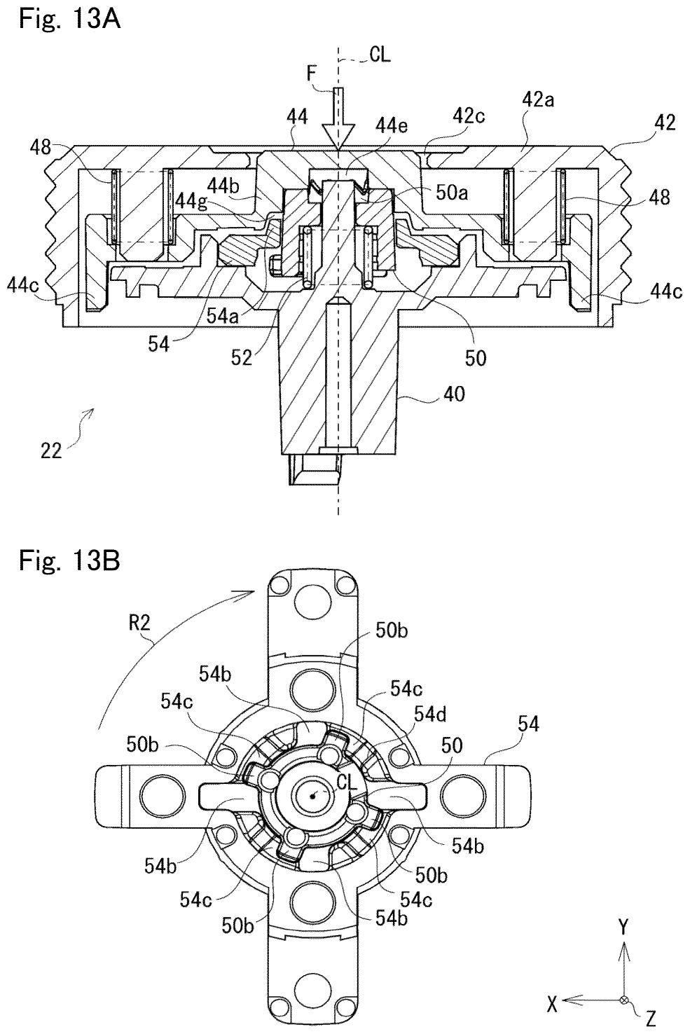

FIG. 13A is a cross-sectional view of the dial in a state where the lock lever member is pressed down to the maximum from the unlocked state. Further, FIG. 13B is a bottom view of the rotating body and the rotating body support member corresponding to FIG. 13A.

As illustrated in FIG. 13A, when the lock lever member 44 is pressed down to the maximum by pressing force F from the user, that is, when the second cam follower portion 50b of the rotating body 50 is located at the position P2 as illustrated in FIG. 12, the cam portion 44e of the lock lever member 44 and the first cam follower portion 50a of the rotating body 50 are in a state of engaging with each other. Further, at this time, the lock lever member 44 comes into contact with the dial base 40, so that further pressing down of the lock lever member 44 by the user is restricted (note that, in the cross section illustrated in FIG. 13A, contact between the lock lever member 44 and the dial base 40 does not appear). Furthermore, the cylindrical portion 54a of the rotating body support member 54 enters a recessed portion 44g formed in the lock lever member 44. That is, when the lock lever member 44 and the rotating body support member 54 come closest to each other, they partially overlap each other. As a result, thickness (size in an extending direction (Z-axis direction) of the rotational center line CL) of the dial 22 can be reduced without reducing a stroke of the lock lever member 44. Furthermore, the coil spring 52 is maximally compressed. Then, as illustrated in FIG. 13B, each of a plurality of the second cam follower portions 50b of the rotating body 50 faces the cam surface 54c of the rotating body support member 54 as viewed in an extending direction (Z-axis direction) of the rotational center line CL.

As illustrated in FIG. 13A, after the lock lever member 44 is pressed down to the maximum by the pressing force F from the user, when the pressing force F is released (for example, when the user's finger is separated from the button portion 44b), the rotating body 50 and the lock lever member 44 move in a direction away from the dial base 40 by biasing force of the coil spring 52. By this, as illustrated in FIG. 12, the second cam follower portion 50b of the rotating body 50 comes into contact with the cam surface 54c of the rotating body support member 54 (position P3).

As illustrated in FIG. 12, the second cam follower portion 50b (at the position P3) in contact with the cam surface 54c of the rotating body support member 54 is biased toward the cam surface 54c by the coil spring 52, and thus slides on the cam surface 54c that is inclined. By the above, the rotating body 50 rotates about the rotational center line CL, and engagement between the cam portion 44e of the lock lever member 44 and the first cam follower portion 50a of the rotating body 50 is released. Then, when the second cam follower portion 50b comes into contact with the stopper portion 54d on the cam surface 54c, sliding on the cam surface 54c of the second cam follower portion 50b stops, that is, rotation of the rotating body 50 stops (position P4). When the second cam follower portion 50b is located at the position P4, the dial 22 is in the locked state.

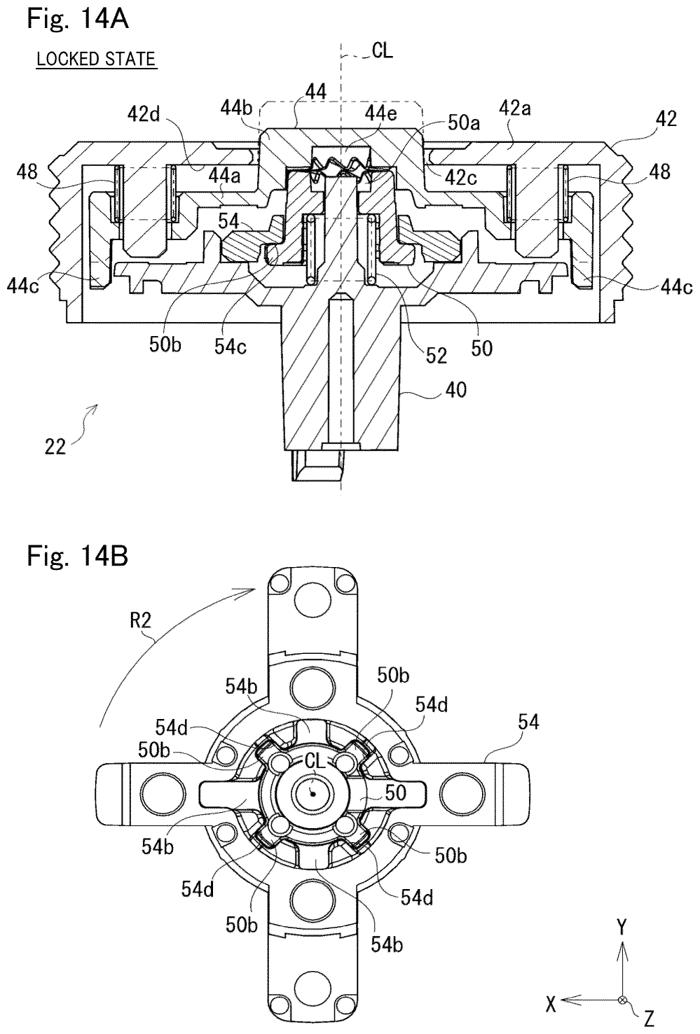

FIG. 14A is a cross-sectional view of the dial in the locked state. Further, FIG. 14B is a bottom view of the rotating body and the rotating body support member corresponding to FIG. 14A.

When the second cam follower portion 50b of the rotating body 50 is in contact with the stopper portion 54d on the cam surface 54c as illustrated in FIG. 12 (position P4), the cam portion 44e of the lock lever member 44 and the first cam follower portion 50a of the rotating body 50 do not engage with each other as illustrated in FIG. 14A. Further, the button portion 44b of the lock lever member 44 is lower than a position of the button portion 44b in the unlocked state (position indicated by a two-dot chain line). Further, the projecting portion 44c of the lock lever member 44 is lower than a position of the projecting portion 44c in the unlocked state (position indicated by a two-dot chain line). This is because, as illustrated in FIG. 14B, the second cam follower portion 50b of the rotating body 50 is caught by the cam surface 54c and the stopper portion 54d of the rotating body support member 54, and the rotating body 50 cannot be pressed up or rotated by the coil spring 52. As a result, the rotating body 50 cannot press the lock lever member 44 forward until the main body portion 44a of the lock lever member 44 comes into contact with the back surface 42d of the top plate 42a of the dial cap 42. That is, biasing the lock lever member 44 via the rotating body 50 of the coil spring 52 is released. At this time, as illustrated in FIG. 7B, a tip of the projecting portion 44c of the lock lever member 44 is located in the recessed portion 24b of the dial lock member 24. By the above, the dial 22 is locked so as not to be rotatable.

Note that, as illustrated in FIG. 14A, the main body portion 44a of the lock lever member 44 is not in contact with the back surface 42d of the top plate 42a of the dial cap 42. However, contact between the lock lever member 44 and the rotating body 50 is maintained by biasing force of the coil spring 48. Further, even when the imaging apparatus 10 is turned upside down, the coil spring 48 is not substantially compressed and deformed by a weight of the lock lever member 44. That is, a total load of a plurality of the coil springs 48 is larger than the weight of the lock lever member 44. As a result, in the locked state, the lock lever member 44 cannot move freely.

Further, as illustrated in FIG. 5, in the unlocked state, the main body portion 44a of the lock lever member 44 is pressed by the rotating body 50 biased by the coil spring 52 and continues to be in contact with the back surface 42d of the top plate 42a of the dial cap 42. As a result, in the unlocked state, the lock lever member 44 cannot move freely.

As described above, the lock lever member 44 cannot move freely in both the locked state and the unlocked state. For this reason, even if a posture of the imaging apparatus 10 changes variously, the lock lever member 44 does not move by its own weight. For this reason, unintended unlocking and generation of rattling sound caused by free movement of the lock lever member 44 along with various changes in a posture of the imaging apparatus 10 are suppressed.

Further, as illustrated in FIG. 14A, since a protruding amount of the button portion 44b of the lock lever member 44 from the through hole 42c of the dial cap 42 is different between the locked state and the unlocked state, the user can know whether the dial 22 is in the locked state or the unlocked state from a protruding amount of the button portion 44b.

When the user presses down the button portion 44b of the lock lever member 44 on the dial 22 in the locked state illustrated in FIG. 14A, the second cam follower portion 50b of the rotating body 50 moves from the position P4 as illustrated in FIG. 12. When the second cam follower portion 50b is separated from the stopper portion 54d (position P5), the rotating body 50 becomes rotatable in the rotational direction R2 about the rotational center line CL.

When the second cam follower portion 50b of the rotating body 50 reaches the position P5, the cam portion 44e of the lock lever member 44 and the first cam follower portion 50a of the rotating body 50, which are not engaging with each other as illustrated in FIG. 14A, start to engage with each other. Specifically, the rotating body 50 starts to rotate in the rotational direction R2 in order for engaging. At this time, since the button portion 44b of the lock lever member 44 is continuously pressed down by the user, the rotating body 50 rotates in the rotational direction R2 while both the lock lever member 44 and the rotating body 50 move toward the dial base 40. As a result, as illustrated in FIG. 12, the second cam follower portion 50b of the rotating body 50 moves to a position P6 between the cam surface 54c of the rotating body support member 54 and the dial base 40 (however, the second cam follower portion 50b is not in contact with the cam surface 54c).

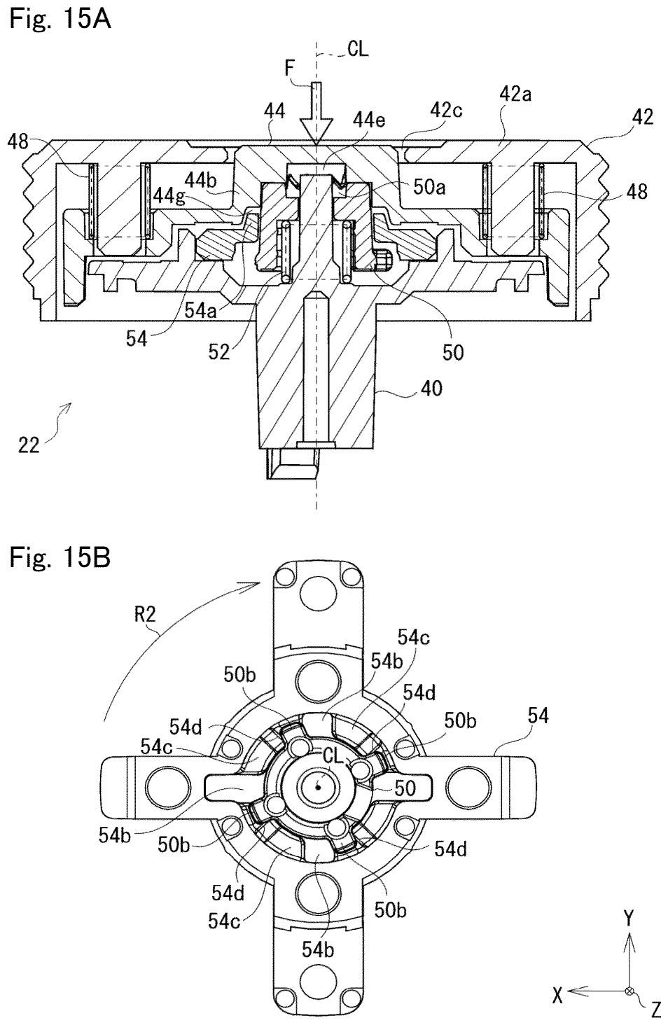

FIG. 15A is a cross-sectional view of the dial in a state where the lock lever member is pressed down to the maximum from the locked state. Further, FIG. 15B is a bottom view of the rotating body and the rotating body support member corresponding to FIG. 15A.

As illustrated in FIG. 15A, when the lock lever member 44 is pressed down to the maximum by the pressing force F from the user, that is, when the second cam follower portion 50b of the rotating body 50 is located at the position P6 as illustrated in FIG. 12, the cam portion 44e of the lock lever member 44 and the first cam follower portion 50a of the rotating body 50 are in a state of engaging with each other. Further, at this time, the lock lever member 44 comes into contact with the dial base 40, so that further pressing down of the lock lever member 44 by the user is restricted (note that, in the cross section illustrated in FIG. 15A, contact between the lock lever member 44 and the dial base 40 does not appear). Furthermore, the coil spring 52 is maximally compressed. Then, as illustrated in FIG. 15B, each of a plurality of the second cam follower portions 50b of the rotating body 50 faces the cam surface 54c of the rotating body support member 54 beyond the stopper portion 54d in the rotational direction R2 as viewed in an extending direction (Z-axis direction) of the rotational center line CL.

As illustrated in FIG. 15A, after the lock lever member 44 is pressed down to the maximum by the pressing force F from the user, when the pressing force F is released, the rotating body 50 and the lock lever member 44 move in a direction away from the dial base 40 by biasing force of the coil spring 52. By this, as illustrated in FIG. 12, the second cam follower portion 50b of the rotating body 50 comes into contact with the cam surface 54c of the rotating body support member 54 (position P7).

As illustrated in FIG. 12, the second cam follower portion 50b (at the position P7) in contact with the cam surface 54c of the rotating body support member 54 is biased toward the cam surface 54c by the coil spring 52, and thus slides on the cam surface 54c that is inclined. By the above, the rotating body 50 rotates about the rotational center line CL, and engagement between the cam portion 44e of the lock lever member 44 and the first cam follower portion 50a of the rotating body 50 is released. Then, finally, the second cam follower portion 50b is separated from the cam surface 54c and enters the guide groove 54b (position P8) (see FIG. 11A). As a result, as illustrated in FIGS. 5 and 7A, the dial 22 becomes in the unlocked state.

That is, when the user performs the pressing down operation of the button portion 44b of the lock lever member 44 twice, the second cam follower portion 50b of the rotating body 50 moves from one of the guide grooves 54b of the rotating body support member 54 to the guide groove 54b adjacent to it. Hereinafter, assembly of the dial 22 will be described.

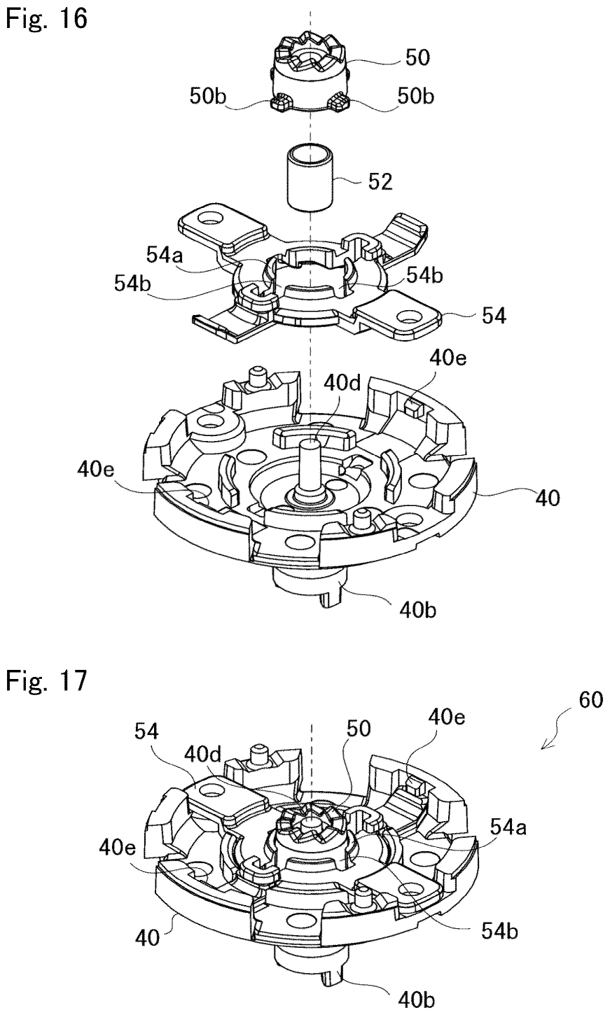

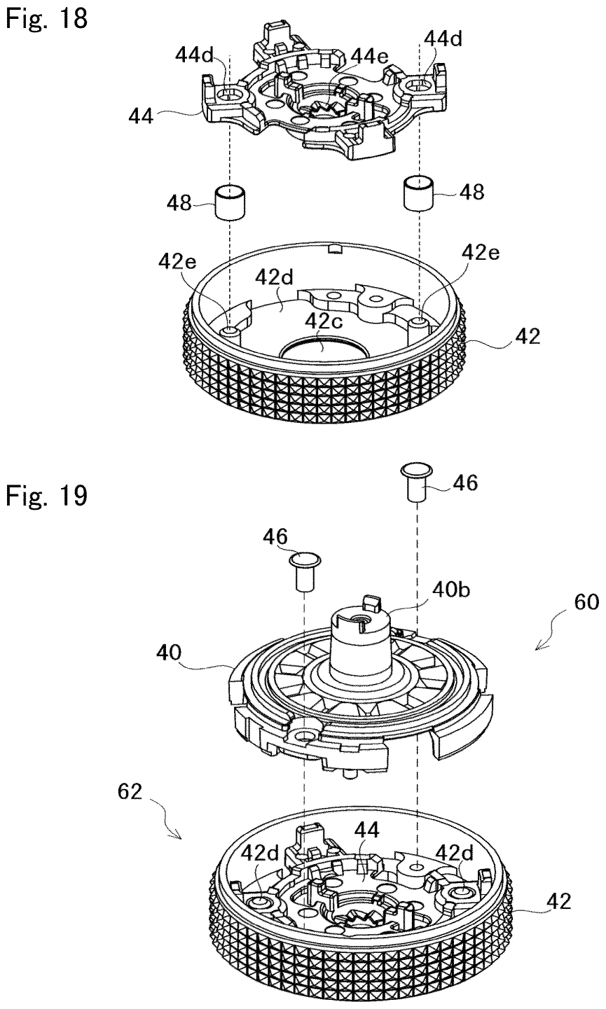

FIG. 16 is a diagram for explaining assembly of a first subassembly in the dial. Further, FIG. 17 is a perspective view of the first subassembly. Furthermore, FIG. 18 is a diagram for explaining assembly of a second subassembly in the dial. Then, FIG. 19 is a diagram for explaining assembly of the first subassembly and the second subassembly.

First, as illustrated in FIGS. 16 and 17, the rotating body 50, the coil spring 52, and the rotating body support member 54 are assembled to the dial base 40 in order to produce a first subassembly 60 in the dial 22. Specifically, first, the rotating body support member 54 is attached to the dial base 40 by snap engagement. For this purpose, the dial base 40 is provided with a snap claw 40e that is caught on the dial base 40 so that the rotating body support member 54 is not detached from the dial base 40. When the rotating body support member 54 is attached and fixed to the dial base 40, the support pin 40d of the dial base 40 is accommodated in the cylindrical portion 54a of the rotating body support member 54.

Next, the coil spring 52 is set in the cylindrical portion 54a of the rotating body support member 54. Subsequently, the rotating body 50 is set so as to cover a tip of the coil spring 52. At this time, the rotating body 50 and the coil spring 52 are inserted into and supported by the support pin 40d of the dial base 40. Further, the cam follower portion 50b of the rotating body 50 is inserted into the guide groove 54b of the rotating body support member 54 and then the rotating body 50 is rotated until the cam follower portion 50b being caught on the stopper portion 54d, so as to be temporarily assembled in the cylindrical portion 54a.

Specifically, the rotating body 50 is pressed toward the dial base 40 against biasing force of the coil spring 52. At this time, the second cam follower portion 50b of the rotating body 50 moves in the guide groove 54b of the cylindrical portion 54a of the rotating body support member 54. When the second cam follower portion 50b disengages from the guide groove 54b, the rotating body 50 is rotated, and the second cam follower portion 50b is caught on the cam surface 54c of the rotating body support member 54. After the above, since the rotating body 50 is biased by the coil spring 52, the second cam follower portion 50b of the rotating body 50 slides on the cam surface 54c and is finally caught by the stopper portion 54d. As a result, the first subassembly 60 illustrated in FIG. 17 is completed.

As illustrated in FIGS. 18 and 19, the coil spring 48 and the lock lever member 44 are assembled to the dial cap 42 in order to produce a second subassembly 62 in the dial 22. First, the dial cap 42 is set in a state where the guide pin 42e faces upward. Next, the coil spring 48 is set on the back surface 42d of the dial cap 42 so as to be inserted through the guide pin 42e. Then, the lock lever member 44 is set on the dial cap 42 in a manner that the guide pin 42e inserted through the coil spring 48 enters the guide hole 44d. At this time, the lock lever member 44 is supported by the coil spring 48 from below. As a result, the second subassembly 62 is completed.

As illustrated in FIG. 19, the first subassembly 60 is assembled to the second subassembly 62. That is, the first subassembly 60 in a state where the shaft portion 40b of the dial base 40 faces upward is set with respect to the second subassembly 62 in a state where the guide pin 42e of the dial cap 42 faces upward. Then, the first subassembly 60 is fixed to the second subassembly 62 via the fixing screw 46. As a result, the dial 22 is completed.

According to the present embodiment as described above, thickness of the dial 22 can be reduced in the operation device 20 including the dial 22 equipped with the alternate mechanism. Specifically, the button portion 44b that is pressed down by the user in order to switch the unlocked state to the locked state or vice versa, and the projecting portion 44c for selectively fixing the dial 22 to the dial lock member 24 are different portions of the lock lever member 44 as one component. For this reason, the button portion 44b is not separated from the projecting portion 44c. As a result, a stroke of the button portion 44b for the separation becomes unnecessary, and thickness (size in an extending direction (Z-axis direction) of the rotational center line CL) of the dial 22 is reduced.

Although the embodiment of the present disclosure is described above with reference to the above embodiment, the embodiment of the present disclosure is not limited to this.

For example, in the above-described embodiment, the alternate mechanism of the dial 22 includes the rotating body 50, the coil spring 52, and the rotating body support member 54. However, the alternate mechanism is not limited to this. A structure of the alternate mechanism is not limited as long as the lock lever member 44 can be moved in a direction of releasing engagement between the projecting portion 44c of the lock lever member 44 and the recessed portion 24b of the dial lock member 24 after the button portion 44b of the lock lever member 44 is pressed down by the user in the locked state.

That is, in a broad sense, the operation device according to an embodiment of the present disclosure includes a dial and a dial lock member including a recessed portion. The dial includes: a lock lever member that is movable in an extending direction of a rotational center line of the dial and includes a button portion, which is pressed down by a user, and a projecting portion, which engages with the recessed portion of the dial lock member to bring the dial into a non-rotatable locked state when the button portion is pressed down; and an alternate mechanism configured to move the lock lever member so as to bring the dial into a rotatable unlocked state in which engagement between the projecting portion and the recessed portion is released after the button portion in the locked state is pressed down by the user.

As described above, the above embodiment is described as an example of the technique in the present disclosure. For this purpose, the drawings and the detailed description are provided. Therefore, the constituent elements described in the drawings and the detailed description include not only constituent elements essential for solving the problem but also constituent elements that are not essential for solving the problem in order to exemplify the technique. Therefore, it should not be immediately recognized that these non-essential constituents are essential based on the fact that these non-essential constituents are described in the drawings and the detailed description.

Further, since the above embodiment is for exemplifying the technique of the present disclosure, various changes, replacements, additions, omissions, and the like can be made within the scope of claims or a scope equivalent to the scope of claims.

The present disclosure is applicable to an imaging apparatus including a dial.

What is claimed is:

1. An operation device comprising:
a dial; and
a dial lock member including a recessed portion, wherein
the dial includes:
a lock lever member that is movable in an extending direction of a rotational center line of the dial and includes a button portion and a projecting portion, the button portion being configured to be pressed down by a user, the projecting portion being configured to engage with the recessed portion of the dial lock member to bring the dial into a non-rotatable locked state when the button portion is pressed down; and
an alternate mechanism configured to moves the lock lever member so as to bring the dial into a rotatable unlocked state in which engagement between the projecting portion and the recessed portion is released after the button portion in the locked state is pressed down by a user.

2. The operation device according to claim 1, wherein
the dial includes a first biasing member that biases the lock lever member in a first direction in which the projecting portion engages with the recessed portion, and
the alternate mechanism is configured to bias the lock lever member in a second direction opposite to the first direction with biasing force larger than biasing force of the first biasing member when in the unlocked state, and releases bias to the lock lever member when in the locked state.

3. The operation device according to claim 2, wherein
the alternate mechanism includes:
a rotating body;
a rotating body support member that supports the rotating body so as to be movable in the extending direction of the rotational center line and so as to be rotatable about the rotational center line; and
a second biasing member that biases the rotating body toward the lock lever member,
the rotating body includes a first cam follower portion having a crown gear shape and provided on an end surface facing the lock lever member, and a second cam follower portion having a projecting shape and protruding in a direction intersecting the extending direction of the rotational center line,
the lock lever member includes a cam portion having a crown gear shape and capable of engaging with the first cam follower portion of the rotating body,
the rotating body support member includes a cylindrical portion that supports an outer peripheral surface of the rotating body so as to be movable in the extending direction of the rotational center line, a guide groove that is formed so as to extend in the extending direction of the rotational center line in the cylindrical portion and guides the second cam follower portion of the rotating body, and a cam surface that is formed on an end surface of the cylindrical portion and on which the second cam follower portion of the rotating body is driven, and
the cam surface of the rotating body support member includes an inclined surface that is inclined while extending in a rotational direction of the rotating body.

4. The operation device according to claim 3, wherein
the button portion of the lock lever member has a bottomed cylindrical shape, and
at least a part of the rotating body is accommodated in the button portion.

5. The operation device according to claim 3, wherein
the rotating body has a cylindrical shape, and
at least a part of the second biasing member is accommodated in the rotating body.

6. The operation device according to claim 3, wherein
the dial lock member is fixed to a bracket member,
the dial further includes:
a dial base rotatably supported by the bracket member; and
a dial cap that is fixed to the dial base, includes a through hole through which the button portion of the lock lever member passes, and is rotated by a user, and
the dial base includes a support pin that extends in the extending direction of the rotational center line and supports the second biasing member.

7. The operation device according to claim 6, wherein
the dial cap includes a guide pin that extends in the extending direction of the rotational center line,
the lock lever member includes a guide hole which the guide pin enters, and
the first biasing member is supported by the guide pin.

8. The operation device according to claim 6, wherein
the rotating body support member is fixed to the dial base by snap engagement.

9. The operation device according to claim 6, wherein
the second biasing member is a coil spring, and
the support pin of the dial base is inserted into the coil spring and the rotating body.

10. The operation device according to claim 3, wherein
the lock lever member includes a recessed portion that enters the cylindrical portion of the rotating body support member when the button portion is pressed down.

11. The operation device according to claim 3, wherein
biasing force to the rotating body of the second biasing member is larger than biasing force to the lock lever member of the first biasing member.

12. The operation device according to claim 3, wherein
a load of the first biasing member is larger than a weight of the lock lever member.

13. An imaging apparatus comprising the operation device according to claim 1.
